(19) United States
(12) Patent Application Publication
(10) Pub. No.: US 2017/0344931 A1
(43) Pub. Date: Nov. 30, 2017

(54) AUTOMATIC TASK FLOW MANAGEMENT ACROSS MULTIPLE PLATFORMS

(71) Applicant: MICROSOFT TECHNOLOGY LICENSING, LLC, Redmond, WA (US)

(72) Inventors: Stephanie Shenk, Seattle, WA (US); Kweku Ako-Adjei, Seattle, WA (US); Lola Jacobsen, Bellevue, WA (US); Timothy Rich, Bellevue, WA (US); Jacqueline Tidwell, Seattle, WA (US); Shiv Bijlani, Seattle, WA (US)

(73) Assignee: MICROSOFT TECHNOLOGY LICENSING, LLC, Redmond, WA (US)

(21) Appl. No.: 15/167,940

(22) Filed: May 27, 2016

(51) Int. Cl. G06Q 10/06; G06Q 10/10; G06F 3/0481

(52) U.S. Cl. CPC G06Q 10/063116; G06F 3/0481; G06Q 10/1097

(57) ABSTRACT

Technologies are provided for automatic task flow management across multiple platforms. In some examples, a user may be prompted to create a task upon analysis of an incoming or an outgoing communication or a task automatically created upon inference. The user may be enabled to define a duration, a priority, and/or a deadline for the task. A calendar item may be created based on task and user attributes such as user's schedule, other activities associated with the task, etc. Created task may be trackable through the calendar and/or through other application user experiences such as a task management application, an email application, and similar ones. Tasks may be closed automatically upon detecting performance of related activities or by the user upon being prompted. Incomplete tasks may be reflowed (and rescheduled on the calendar) automatically based on task, schedule, and other related factors.

### BACKGROUND

An average person is typically burdened with a large number of personal and professional tasks in their daily lives. With the proliferation of computers and utility programs, many people use email, calendar, and scheduling applications for managing tasks and information associated with tasks. For example, a common scenario includes a person recording their tasks manually in a calendar application and changing their status manually when the task is completed. Task management applications perform similar actions.

However, conventional use of calendar, task, and scheduling applications for task management is typically static relying on people to manage the tasks, their scheduling, and completion manually. With the increasing number of personal and professional tasks, the functionality and capabilities of such applications may be insufficient to address the needs of the people.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to automatic task flow management across multiple platforms. In some examples, upon receiving a communication, the communication may be analyzed to infer a task, which may include task attributes. The inferred task may be created in response to user confirmation or automatically based on one or more of default values and user input for the task attributes. Information associated with the task and the task attributes may be provided to a calendar application such that a calendar item is created for the task based on one or more of the task attributes, a user attribute, and one or more events surrounding the calendar item. In other examples, the task may be reflowed and the calendar application instructed to reschedule the calendar item automatically in response to a user input, a conflicting calendar item creation, or lack of task completion by a task deadline.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a display diagram illustrating an example system for automatic task flow management across multiple platforms;

FIG. 2 is a display diagram illustrating major components and interactions in providing automatic task flow management across multiple platforms;

FIG. 3 is a display diagram illustrating automatic task flow management across multiple platforms in a collaborative environment;

FIG. 4 is a display diagram illustrating an example email application user experience that enables automatic task flow management across multiple platforms;

FIG. 5 is a display diagram illustrating an example task creation/viewing user experience according to some embodiments;

FIG. 6 is a display diagram illustrating an example calendar user experience with automatic task flow management across multiple platforms;

FIG. 7 is a block diagram of an example computing device, which may be used for providing automatic task flow management across multiple platforms, according to embodiments; and

FIG. 8 is a logic flow diagram illustrating a process for providing automatic task flow management across multiple platforms, according to embodiments,

### DETAILED DESCRIPTION

As briefly described above, embodiments are directed to automatic task flow management across multiple platforms. In some examples, a user may be prompted to create a task upon analysis of an incoming or an outgoing communication (email, instant message, online conference, etc.) or a task automatically created upon inference. The user may be enabled to define a duration, a priority, and/or a deadline for the task. A calendar item may be created based on task and user attributes such as user's schedule, other activities associated with the task, etc. Created task may be trackable through the calendar and/or through other application user experiences such as a task management application, an email application, and similar ones. Tasks may be closed automatically upon detecting performance of related activities or by the user upon being prompted. Incomplete tasks may be reflowed (and rescheduled on the calendar) automatically based on task, schedule, and other related factors. Tasks may be split over different time periods or not based on user preferences or task attributes. Furthermore, subtasks may be created from a single task or combined under an umbrella task based on user input or automatic inference.

While a task managed by a task management application and a corresponding calendar item managed by a calendar application are used as examples herein, embodiments are not limited to two distinct objects. In some embodiments, the task and the calendar item may be one and the same object managed by the task management application, the calendar application, and/or both. Thus, two distinct views (task and calendar) of the same object may be provided to the user while the same object is used to maintain task information.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents,

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing task management. Examples of platforms include, but are not limited to, a hosted service executed over a plurality of servers, an application executed on a single computing device, a device operating system, and comparable systems. The term “server” generally refers to a computing device executing one or more software programs typically in a networked environment. More detail on these technologies and example operations is provided below.

A computing device, as used herein, refers to a device comprising at least a memory and one or more processors that includes a server, a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. Actions or operations described herein may be executed on a single processor, on multiple processors (in a single machine or distributed over multiple machines), or on one or more cores of a multi-core processor. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that allow the application or service to interact or communicate with one or more other applications and services managed by separate entities.

The technical advantages of providing automatic task flow management across multiple platforms may include, among others, increased efficiency and collaboration through automated task management on multiple platforms such as task management applications, calendar applications, communication applications. User experience may also be enhanced through inference based automation of task management and scheduling operations.

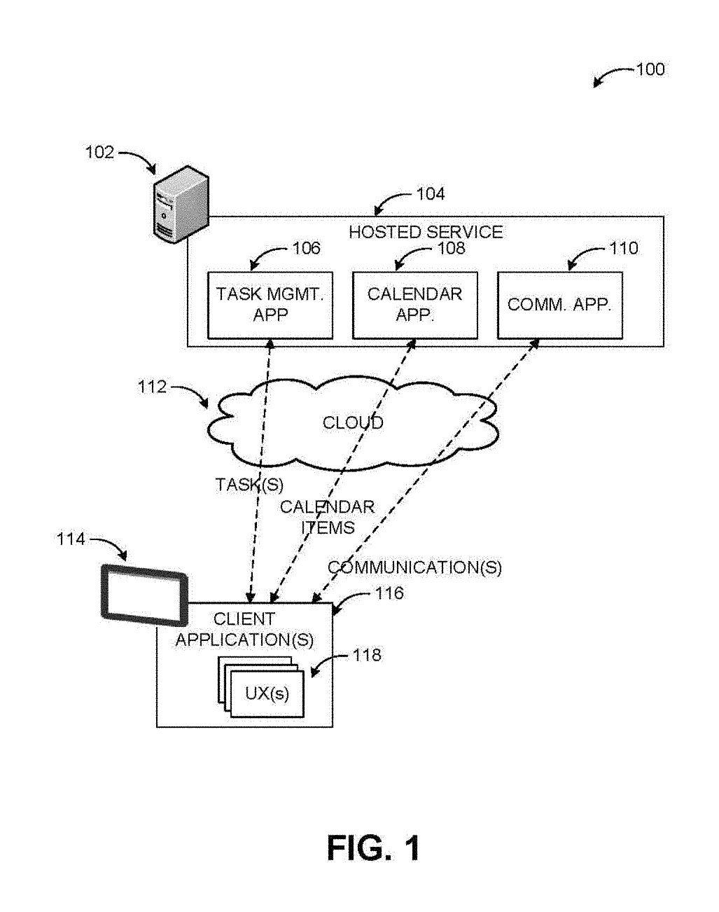

FIG. 1 is a display diagram illustrating an example system for automatic task flow management across multiple platforms.

As shown in diagram 100, a hosted service 104 executed on one or more servers such as server 102 may include a number of applications such as task management application 106, calendar application 108, communication application 110, and comparable ones. The hosted service 104 may allow users to access its services via client applications 116 executed on client devices such as table computer 114 over a cloud 112. The task management application 106 may manage tasks, calendar application 108 may schedule and manage calendar items, and the communication application 110 may enable communication among users over multiple modalities such as email, instant messaging, audio/video conferences, application sharing, and similar ones.

The individual applications described herein and others may also be standalone applications external to the hosted service 104, or part of separate services. Client applications 116 may be thick or thin client applications. That is, they may include locally installed applications providing functionality at the local level, or they may be web browser(s) that simply provide access to the hosted service for the service functionalities.

In some embodiments, the task management application 106 may analyze incoming or outgoing communications, or similar items associated with a user and infer a task to be created. The task management application may then prompt the user to confirm the task along with its attributes or define the task and its attributes. The task's attributes may include, but are not limited to, duration, deadline, priority, times to schedule, times not schedule, addition of data such as files, and sharing attributes. Upon user confirmation, the task may be created based on the confirmed attributes. In other embodiments, the task management application 106 may infer and create the task (and its attributes) automatically.

The task management application 106 may then provide information associated with the task and the task attributes to the calendar application 108 such that a calendar item is created for the task based on one or more of the task attributes, a user attribute, and one or more events surrounding the calendar item. Subsequently, the task may be reflowed and the scheduled calendar item rescheduled in response to a user request, a conflicting calendar item being created, or the task not being completed at the scheduled time.

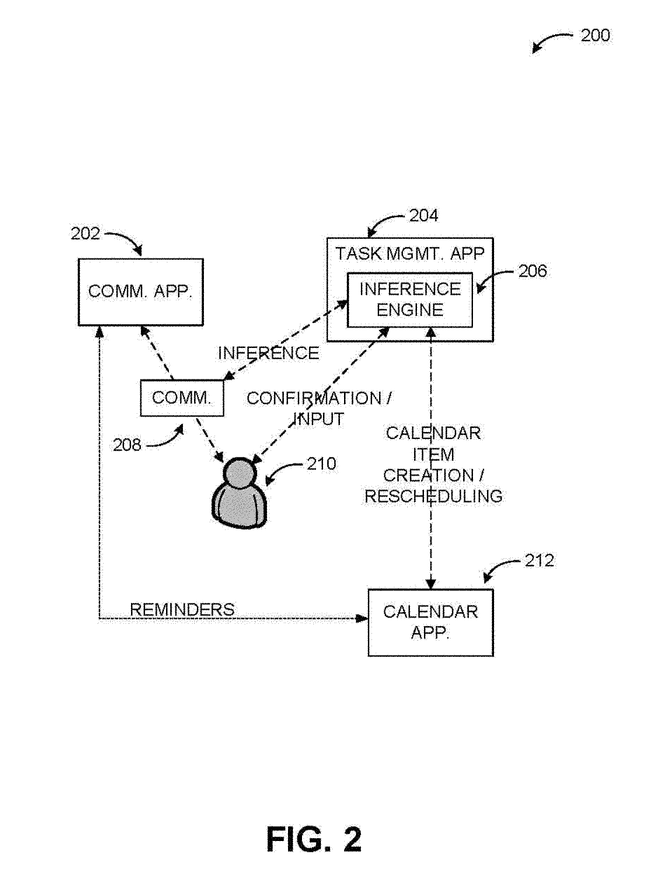

FIG. 2 is a display diagram illustrating major components and interactions in providing automatic task flow management across multiple platforms.

Diagram 200 shows a communication 208 being sent or received by the user 210 through a communication application 202. The task management application 204 may include an inference engine 206, which may analyze the communication 208 to infer a task (and its attributes) and create the task upon confirmation or input from the user 210. The task management application may also receive input through a personal assistant (i.e., voice input). The task management application 206 may then instruct the calendar application 212 to create a calendar item. Upon reflow of the task by the task management application 206 in response to a user request, a conflicting calendar item being created, or the task not being completed at the scheduled time, the calendar application 212 may also reschedule the calendar item.

In some embodiments, the task management application 206 may receive a modification of one or more of the task attributes through the calendar item and modify the one or more task attributes and vice versa. The task management application 206 or the calendar application 212 may provide reminder(s) to the user 210 (e.g., through the communication application 202 when a deadline of the task is approaching, for example.

In other embodiments, the task management application 206 may reflow the task and instruct the calendar application 212 to reschedule the calendar item in response to determining a deadline for the task is a predefined time period away from a current time (e.g., a day, an hour, etc.). Similarly, a priority of the task may be modified in response to determining a deadline for the task is a predefined time period away from a current time.

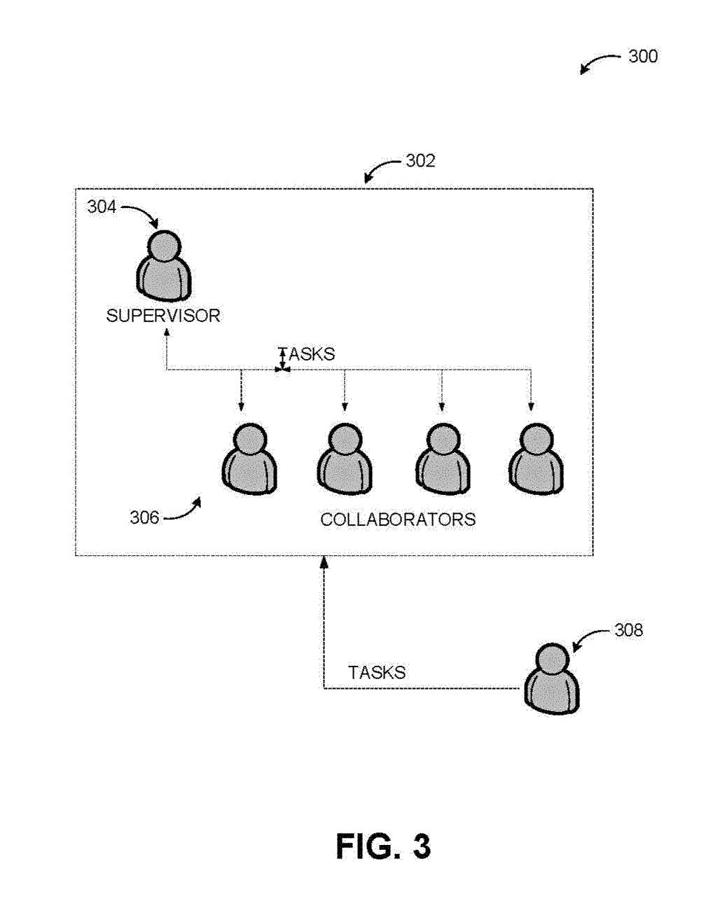

FIG. 3 is a display diagram illustrating automatic task flow management across multiple platforms in a collaborative environment.

While some embodiments may be directed to task creation and management at a single user level, other embodiments may include automatic task management in collaborative environments. As diagram 300 shows, a collaborating group 302 may include peers 306 and a supervisor 304. In some examples, a task or a set of tasks may be created based on direct request or inference for one or more of the members of the collaborative group 302. The request or inference may be based on a communication from any one of the peers 306, supervisor 304, or an external (non-member) user 308.

The set of tasks may be coordinated. For example, some tasks may depend on other tasks being completed. Thus, the scheduling and rescheduling of calendar items corresponding to the tasks may be performed with the dependency of the tasks in mind. If a task is not completed down-level tasks for the same or other users may be rescheduled or their priorities modified in response to the incomplete status of the original task. Furthermore, progress of related tasks may be provided to users to inform them and allow the users to plan their schedules.

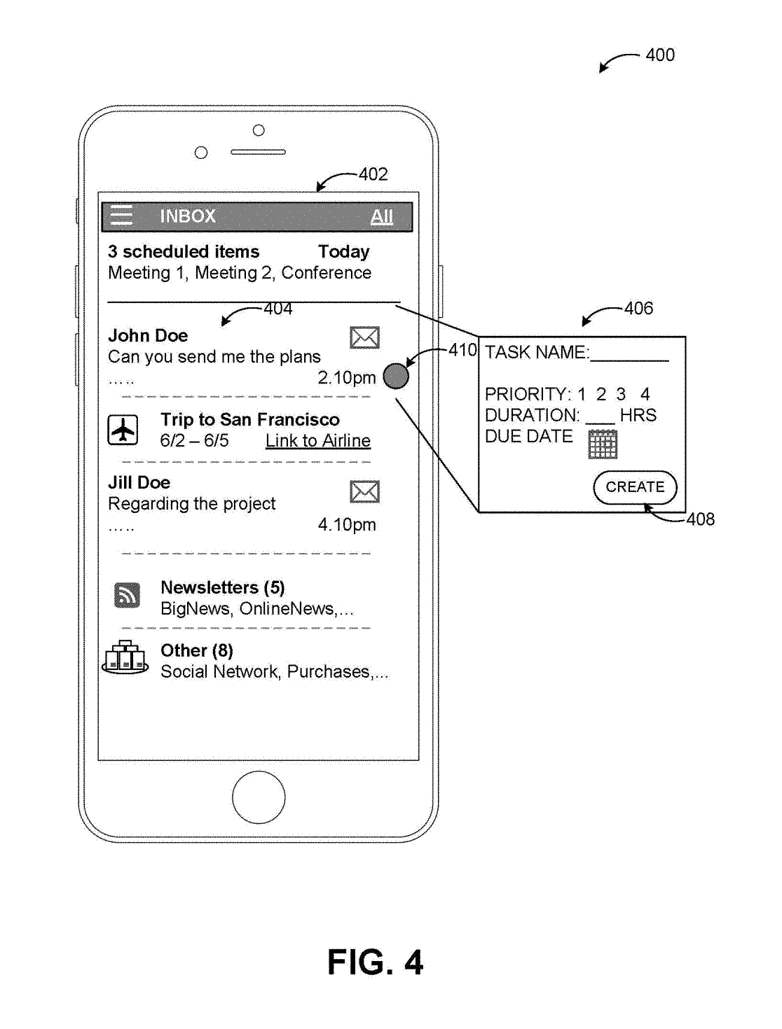

FIG. 4 is a display diagram illustrating an example email application user experience that enables automatic task flow management across multiple platforms.

Diagram 400 shows a user experience 402 of an email application on a mobile platform. Embodiments may, of course, be implemented in other platforms and in conjunction with other applications such as instant messaging applications, online conferencing applications, application or data sharing applications, and calendar applications, for example.

In the example user experience 402, an email 404 may be analyzed and a task inferred from the analysis. Upon inference of the task, a task creation prompt 406 may be automatically displayed to the user. Alternatively, a control 410 (e.g., a button) may be displayed in conjunction with the email allowing the user to select creation of the task (and display of the task creation prompt 406). The task creation prompt 406 may allow the user to confirm or define task attributes such as duration, deadline, priority, times to schedule/not schedule, add files. User may be enabled to input information through text input or through graphical element such as display of a calendar to select the deadline. A “create” control 408 may allow the user to confirm the creation of the task.

In other embodiments, a completion deadline, a duration, a priority of the task, and/or other attributes may be predicted by the task management application.

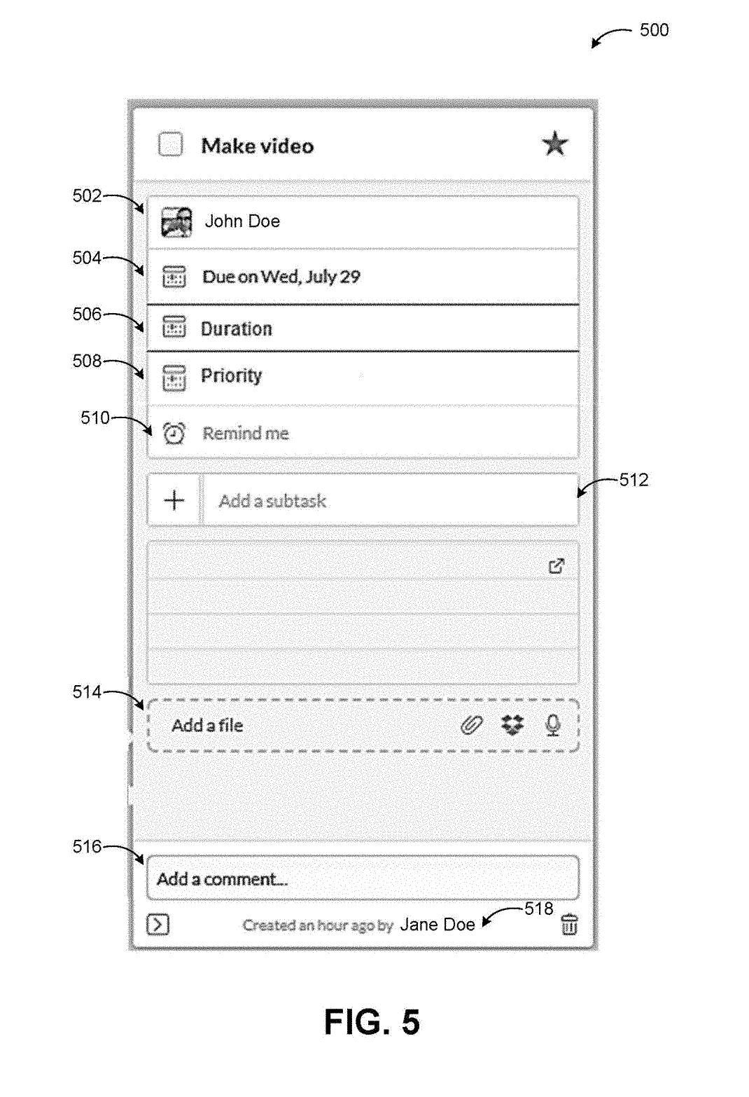

FIG. 5 is a display diagram illustrating an example task creation/viewing user experience according to some embodiments.

The example user experience in diagram 500 may be used to allow a user to define (or confirm) task attributes. The same user experience may also be used to display to the user the attributes of an already created task. The attributes/elements on the example user experience are for illustration purposes only and do not constitute a limitation on embodiments. User experiences for task attribute definition/confirmation may be implemented with additional or fewer elements.

Example user experience includes name of the user 502, deadline 504, duration 506, priority 508, reminder setting 510, and subtask(s) 512. Thus, a reminder associated with the task may be issued automatically by the task management application based on default triggers or based on definition by the user. The user may also define subtasks. The subtasks may be incremental tasks associated with the task.

The user may also be allowed to add one or more files to the task through file attachment control 514. The files may be added through attachment, recording, or other means. The user may be further allowed to add comments to the task through a comment control 516. The comments may be used especially in collaborative environments. Moreover, if the task is created in a collaborative environment, the creator (518) may be displayed on the user experience as well.

The user interface in FIG. 5 is for illustration purposes, specifically, for illustrating integration of multiple aspects of embodiments. Thus, embodiments are not limited to the shown elements, their order, or presentation.

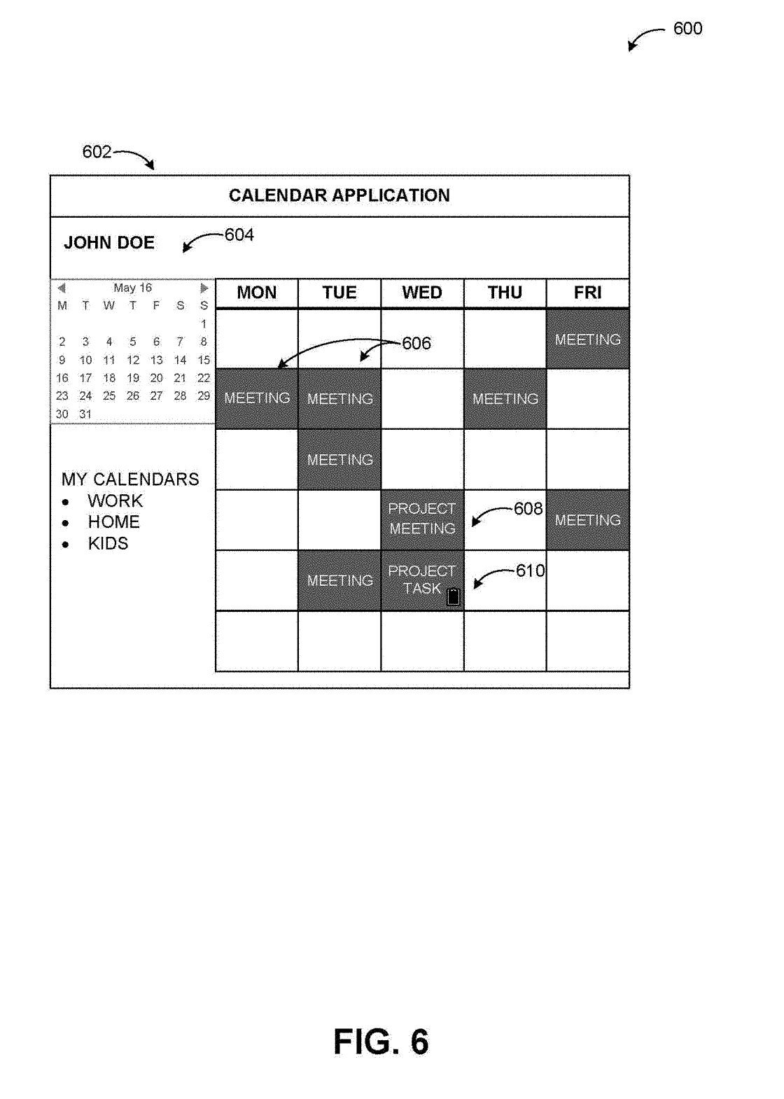

FIG. 6 is a display diagram illustrating an example calendar user experience with automatic task flow management across multiple platforms.

Calendar application user experience 602 in diagram 600 includes calendar items such as meetings 606 for user 604. A task related calendar item 610 may be displayed similar to other calendar items but with an indication such as an icon or other graphic or textual indication to emphasize the item as a task item.

As discussed above, the task may be created based on, among other things, calendar items. For example, user 604 may have a meeting scheduled for a particular project (project meeting 608). Recognizing the meeting and available time following the meeting, the task management application may instruct the calendar application to schedule the task item following the project meeting. In some embodiments, the task creation and management may be performed by a module integrated with the calendar application managing the scheduling and rescheduling of calendar items associated with tasks directly.

Task based calendar items may be scheduled as a single item based on user schedule availability. In other embodiments, the task related calendar items may be split. For example, two items may be created on consecutive days. Thus, the task may be divided into incremental subtasks. Task attributes may also define whether the time reserved for the task related calendar item is to be indicated on the calendar as available, busy, tentative, or otherwise. The calendar item may include a check control for the user to indicate completion. In further embodiments, the completion of the task may be automatically detected by the task management application. Machine learning techniques may be used to predict a deadline and/or completion of the task.

In yet other embodiments, tasks may be reorganized/rescheduled upon a prolonged absence of the user (vacation, illness, etc.). Tasks that are not completed with repeated missed deadlines may be automatically re-prioritized based on information associated with them. For example, if a project deadline is approaching tasks associated with that project may be set to higher priority and scheduled accordingly. Priorities and approaching deadlines of tasks may be presented to the user through a variety of ways. Messages (email, text message, on-screen message, etc.) may be provided. A color, textual scheme, or graphic scheme of the displayed calendar item may be changed in response to a priority change or approaching deadline.

A textual scheme, a graphical scheme, an animation scheme, a coloring scheme, a highlighting scheme, and/or a shading scheme may be employed to provide automatic task flow management across multiple platforms in conjunction with the functionality described herein.

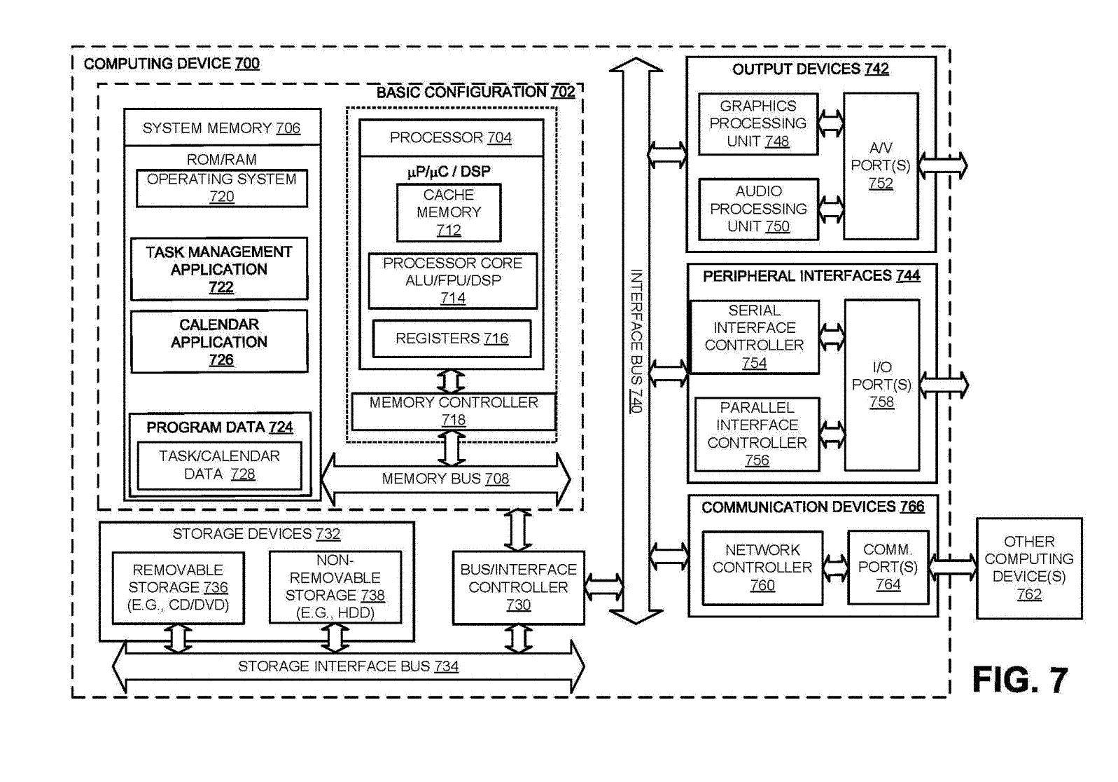

FIG. 7 is a block diagram of an example computing device, which may be used for providing automatic task flow management across multiple platforms, according to embodiments.

For example, a computing device 700 may be used as a desktop computer, portable computer, smart phone, special purpose computer, or similar device. In an example basic configuration 702, the computing device 700 may include one or more processors 704 and a system memory 706. A memory bus 708 may be used for communication between the processor 704 and the system memory 706. The example basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The one or more processor cores 714 may (each) include an arithmetic logic unit (ALU), a floating point unit (FPU), a digital signal processing core (DSP Core), or any combination thereof. An example memory controller 718 may also be used with the processor 704, or in some implementations, the example memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, a task management application 722, a calendar application 726, and program data 724. The task management application 722 may create and manage (e.g., reflow) tasks in response to a direct user input or inference from a communication. The task management application 722 may also instruct the calendar application 726 to create a calendar item corresponding to the task, which may be created based on task, user, and calendar attributes, and rescheduled automatically in response to a user input, a conflicting calendar item creation, or lack of task completion by a task deadline as discussed herein. Program data 724 may include, among others, task/calendar data 728 associated with automatic task flow management across multiple platforms.

The computing device 700 may have additional features or functionality, and additional interfaces to facilitate communications between the example basic configuration 702 and any desired devices and interfaces. For example, a bus/interface controller 730 may be used to facilitate communications between the example basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the example basic configuration 702 via the bus/interface controller 730. Some of the one or more output devices 742 include a graphics processing unit 748 and an audio processing unit 750, which may be configured to communicate to various external devices such as a display or speakers via one or more A/V ports 752. The one or more peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media.

Example embodiments may also include methods for providing infrared illumination through background lighting sources. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

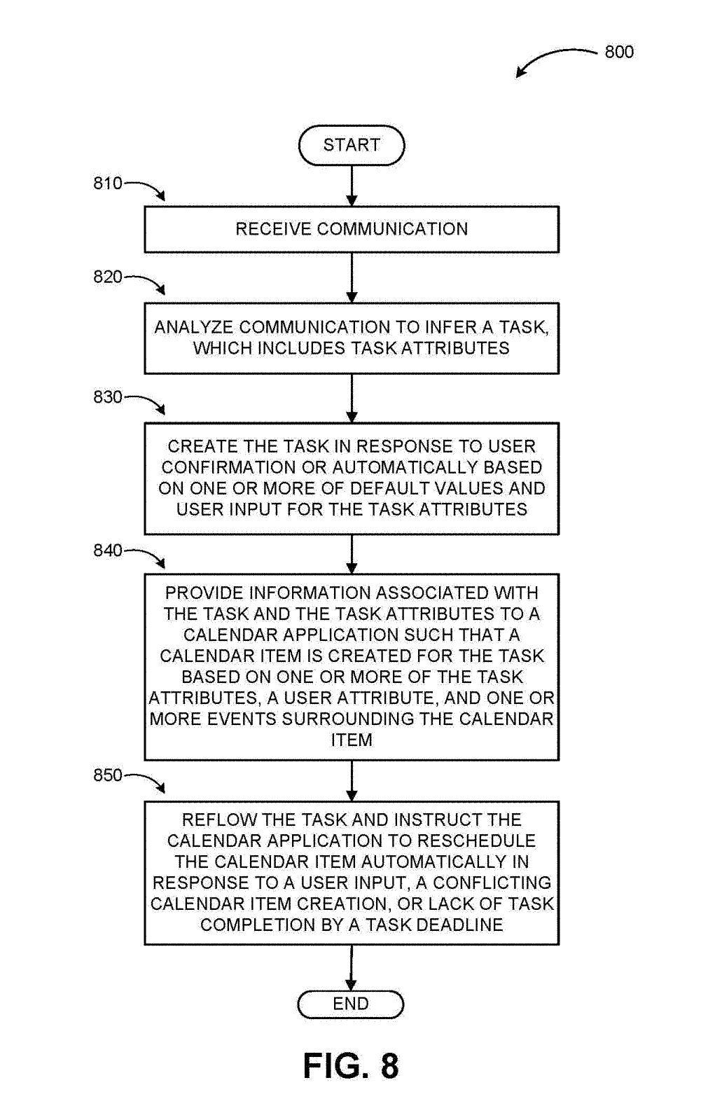

FIG. 8 is a logic flow diagram illustrating a process for providing automatic task flow management across multiple platforms, according to embodiments. A process 800 may be implemented by a task management application, a calendar application, a productivity suite, or similar applications/services executed on a mobile or stationary computing device or networked system.

The process 800 may begin with operation 810, where a communication such as an email, an instant message, an online conference, and a personal assistant input may be received at a task management application. The task management application (or module) may analyze the communication at operation 820 to infer a task. In some embodiments, a user may prompted to confirm (or to define) the task. In other embodiments, the inferred task may be automatically created at operation 830. The task may include attributes such as a deadline, a duration, a priority, and others. The task attributes may also be inferred, set to default values, or defined (confirmed) by the user.

At operation 840, information associated with the task and the task attributes may be provided to a calendar application such that a calendar item is created for the task based on one or more of the task attributes, a user attribute, and one or more events surrounding the calendar item. At operation 850, the task may be automatically reflowed and the calendar application instructed to reschedule the calendar item if a user input to that effect is received, a conflicting calendar item is created, or the task is not completed by a task deadline.

The operations included in process 800 are for illustration purposes. Providing automatic task flow management across multiple platforms may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some examples, a computing device to provide automatic task flow management across multiple platforms is described. The computing device may include a display configured to present user experiences for one or more applications, a memory configured to store instructions, and a processor coupled to the display and the memory and configured to execute a task management application in conjunction with the instructions stored in the memory. The task management application may be configured to in response to analyzing a communication or receiving a user input, display a prompt to create a task, where the task includes task attributes; create the task based on the task attributes; provide information associated with the task and the task attributes to a calendar application such that a calendar item is created for the task based on one or more of the task attributes, a user attribute, and one or more events surrounding the calendar item; and in response to a user input, a conflicting calendar item creation, or lack of task completion by a task deadline, automatically reflow the task and instruct the calendar application to reschedule the calendar item.

According to other examples, the task management application may be further configured to receive a modification of one or more of the task attributes through the calendar item and modify the one or more task attributes at the task management application. The task management application may also be configured to provide the task to one or more applications including an email application, an instant message application, an online conference application, and a personal assistant. The communication may include an email, an instant message, an online conference, or a personal assistant input. The task attributes may include a duration, a priority, a deadline, a time period during which to schedule the task, a time period during which to exclude the task, data to be associated with the task, or a share attribute. The task attributes may further include whether the calendar item is to be a single item, whether the calendar item is to be split into multiple items, and whether the calendar item is to be marked as busy, away, or available.

According to further examples, the task management application may be further configured to instruct the calendar application to create the calendar item and to reschedule the calendar item in conjunction with one or more other calendar items related to the task. The one or more other calendar items may be non-task calendar items. The task management application may also reflow the task and instruct the calendar application to reschedule the calendar item in response to determining a deadline for the task is a predefined time period away from a current time. The task management application may further modify a priority of the task in response to determining a deadline for the task is a predefined time period away from a current time, or enable transmission of a reminder associated with the task in response to determining a deadline for the task is a predefined time period away from a current time through one or more communication modalities.

According to other examples, a method executed at a computing device to provide automatic task flow management across multiple platforms is described. The method may include receiving a communication; analyzing the communication to infer a task, where the task includes task attributes; creating the task based on one or more of default values and user input for the task attributes; providing information associated with the task and the task attributes to a calendar application such that a calendar item is created for the task based on one or more of the task attributes, a user attribute, and one or more events surrounding the calendar item; and in response to a user input, a conflicting calendar item creation, or lack of task completion by a task deadline, automatically reflowing the task and instructing the calendar application to reschedule the calendar item.

According to some examples, analyzing the communication to infer the task may include predicting one or more of a completion deadline, a duration, and a priority of the task. Providing information associated with the task and the task attributes to the calendar application may include enabling scheduling of multiple calendar items corresponding to multiple tasks. The multiple tasks may include subtasks associated with the task or incremental tasks associated with the task. The method may also include reflowing the task based on a status of one or more of a related task and a user availability.

According to further examples, a computer-readable memory device with instructions stored thereon to provide automatic task flow management across multiple platforms is described. The instructions may cause a processor of a computing device to perform actions. The actions may include receiving a communication; analyzing the communication to infer a task; prompting a user to confirm the inferred task and one or more task attributes; creating the task based on one or more of default values and user input for the task attributes; providing information associated with the task and the task attributes to a calendar application such that a calendar item is created for the task based on one or more of the task attributes, a user attribute, and one or more events surrounding the calendar item; enabling transmission of a reminder associated with the task in response to determining a deadline for the task is a predefined time period away from a current time through one or more communication modalities; and in response to a user input, a conflicting calendar item creation, or lack of task completion by a task deadline, automatically reflowing the task and instructing the calendar application to reschedule the calendar item.

According to yet other examples, the instructions may further include receiving a request to create a set of tasks to be assigned to one or more collaborators in a collaborative environment; and providing information associated with the set of tasks to calendar applications associated with the one or more collaborators such that a set of calendar items are created for the set of tasks for each collaborator. The instructions may also include updating the one or more collaborators on a progress associated with each task of the set of tasks; and automatically reflowing the set of tasks and instructing the set of calendar applications to reschedule the set of calendar items in response to a completion or a rescheduling of one of the set of tasks. The set of tasks may be created by one or more of a supervisor of the collaborative environment, one of the one or more collaborators, and a non-member of the collaborative environment.

According to examples, a means for providing automatic task flow management across multiple platforms is described. The means may include a means for receiving a communication; a means for analyzing the communication to infer a task, where the task includes task attributes; a means for creating the task based on one or more of default values and user input for the task attributes; a means for providing information associated with the task and the task attributes to a calendar application such that a calendar item is created for the task based on one or more of the task attributes, a user attribute, and one or more events surrounding the calendar item; and in response to a user input, a conflicting calendar item creation, or lack of task completion by a task deadline, a means for automatically reflowing the task and instructing the calendar application to reschedule the calendar item.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide automatic task flow management across multiple platforms, the computing device comprising:
a display configured to present user experiences for one or more applications;
a memory configured to store instructions; and
a processor coupled to the display and the memory, and configured to execute a task management application in conjunction with the instructions stored in the memory, wherein the task management application is configured to:
in response to analyzing a communication or receiving a user input, display a prompt to create a task, wherein the task includes task attributes;
create the task based on the task attributes;
provide information associated with the task and the task attributes to a calendar application such that a calendar item is created for the task based on one or more of the task attributes, a user attribute, and one or more events surrounding the calendar item; and
in response to one of a user input, a conflicting calendar item creation, and lack of task completion by a task deadline, automatically reflow the task and instruct the calendar application to reschedule the calendar item.

2. The computing device of claim 1, wherein the task management application is further configured to:
receive a modification of one or more of the task attributes through the calendar item; and
modify the one or more task attributes at the task management application.

3. The computing device of claim 1, wherein the task management application is further configured to:
provide the task to one or more applications including an email application, an instant message application, an online conference application, and a personal assistant.

4. The computing device of claim 1, wherein the communication includes one of an email, an instant message, an online conference, and a personal assistant input.

5. The computing device of claim 1, wherein the task attributes include a duration, a priority, a deadline, a time period during which to schedule the task, a time period during which to exclude the task, data to be associated with the task, or a share attribute.

6. The computing device of claim 5, wherein the task attributes further include whether the calendar item is to be a single item, whether the calendar item is to be split into multiple items, and whether the calendar item is to be marked as one of busy, away, and available.

7. The computing device of claim 1, wherein the task management application is further configured to:
instruct the calendar application to create the calendar item and to reschedule the calendar item in conjunction with one or more other calendar items related to the task.

8. The computing device of claim 7, wherein the one or more other calendar items are non-task calendar items.

9. The computing device of claim 1, wherein the task management application is further configured to:
reflow the task and instruct the calendar application to reschedule the calendar item in response to determining a deadline for the task is a predefined time period away from a current time.

10. The computing device of claim 1, wherein the task management application is further configured to:
modify a priority of the task in response to determining a deadline for the task is a predefined time period away from a current time.

11. The computing device of claim 1, wherein the task management application is further configured to:
enable transmission of a reminder associated with the task in response to determining a deadline for the task is a predefined time period away from a current time through one or more communication modalities.

12. A method executed at a computing device to provide automatic task flow management across multiple platforms, the method comprising:
receiving a communication;
analyzing the communication to infer a task, wherein the task includes task attributes;
creating the task based on one or more of default values and user input for the task attributes;
providing information associated with the task and the task attributes to a calendar application such that a calendar item is created for the task based on one or more of the task attributes, a user attribute, and one or more events surrounding the calendar item; and
in response to one of a user input, a conflicting calendar item creation, and lack of task completion by a task deadline, automatically reflowing the task and instructing the calendar application to reschedule the calendar item.

13. The method of claim 12, wherein analyzing the communication to infer the task comprises:
predicting one or more of a completion deadline, a duration, and a priority of the task.

14. The method of claim 12, wherein providing information associated with the task and the task attributes to the calendar application comprises:
enabling scheduling of multiple calendar items corresponding to multiple tasks.

15. The method of claim 14, wherein the multiple tasks include one of subtasks associated with the task and incremental tasks associated with the task.

16. The method of claim 12, further comprising:
reflowing the task based on a status of one or more of a related task and a user availability.

17. A computer-readable memory device with instructions stored thereon to provide automatic task flow management across multiple platforms, the instructions configured to cause a processor of a computing device to perform actions, wherein the actions comprise:
receiving a communication;
analyzing the communication to infer a task;
prompting a user to confirm the inferred task and one or more task attributes;
creating the task based on one or more of default values and user input for the task attributes;
providing information associated with the task and the task attributes to a calendar application such that a calendar item is created for the task based on one or more of the task attributes, a user attribute, and one or more events surrounding the calendar item;
enabling transmission of a reminder associated with the task in response to determining a deadline for the task is a predefined time period away from a current time through one or more communication modalities; and
in response to one of a user input, a conflicting calendar item creation, and lack of task completion by a task deadline, automatically reflowing the task and instructing the calendar application to reschedule the calendar item.

18. The computer-readable memory device of claim 17, wherein the instructions further comprise:
receiving a request to create a set of tasks to be assigned to one or more collaborators in a collaborative environment; and
providing information associated with the set of tasks to calendar applications associated with the one or more collaborators such that a set of calendar items are created for the set of tasks for each collaborator.

19. The computer-readable memory device of claim 18, wherein the instructions further comprise:
updating the one or more collaborators on a progress associated with each task of the set of tasks; and
automatically reflowing the set of tasks and instructing the set of calendar applications to reschedule the set of calendar items in response to one of a completion and a rescheduling of one of the set of tasks.

20. The computer-readable memory device of claim 18, wherein the set of tasks are created by one or more of a supervisor of the collaborative environment, one of the one or more collaborators, and a non-member of the collaborative environment.
